(19) United States
(12) Patent Application Publication
(10) Pub. No.: US 2026/0331321 A1
(43) Pub. Date: Oct. 22, 2026

(54) APPARATUS, SYSTEM, AND METHODS FOR HANDLING SPENT NUCLEAR FUEL

(71) Applicant: Holtec International, Camden, NJ (US)

(72) Inventors: Krishna P. Singh, Jupiter, FL (US); Stephen J. AGACE, Middletown, DE (US)

(73) Assignee: Holtec International, Camden, NJ (US)

(21) Appl. No.: 19/098,936

(22) Filed: Apr. 2, 2025

Related U.S. Application Data
(60) Provisional application No. 63/573,038, filed on Apr. 2, 2024.

(51) Int. Cl. G21F 5/14; G21F 5/008; G21F 5/02

(52) U.S. Cl. CPC G21F 5/14; G21F 5/008; G21F 5/02

(57) ABSTRACT

A radiation shielding cask apparatus that comprises a cask body, a bottom lid, and a plurality of canister support elements. The cask body defines a cavity configured to receive a canister containing spent nuclear fuel. The bottom lid detachably coupled to the cask body to enclose a bottom end of the cavity. The plurality of canister support elements coupled to a bottom portion of the cask body and alterable between: (1) a canister support state in which the canister support elements protrude into the cavity, support the canister, and prohibit the canister from being removed from the cavity via the bottom end of the cavity; and (2) a canister unloading state in which the canister support elements are retracted and allow the canister to be removed from the cavity via the bottom end of the cavity when the bottom lid is removed from the cask body.

### CROSS-REFERENCE TO RELATED APPLICATIONS

The present application claims the benefit of priority to U.S. Provisional Application No. 63/573,038 filed on Apr. 2, 2024, which is incorporated herein by reference in its entirety.

### FIELD OF THE INVENTION

The present invention relates generally to casks used to transport and store spent nuclear fuel created by nuclear generating plants or other facilities.

### BACKGROUND OF THE INVENTION

A typical transfer cask features a main body designed to structurally protect the spent nuclear fuel stored in the fuel canister inside it. A common configuration consists of concentrically arranged steel shells filled with lead. Such a cask body made with high-density conductive materials has excellent heat conduction and gamma radiation shielding capabilities, but unfortunately possesses a relatively modest neutron capture capability. For capturing neutrons, a hydrogenous material is needed which is generally provided by a jacket filled with water or a solid resinous material integrally and permanently joined to the main cask body.

This traditional transfer cask design suffers from several drawbacks which makes it marginal or unsuitable for loading canisters with high decay heat generation rates (i.e., in excess of 40 kW), in locations where the crane capacity is less than what is typically needed to load such a heavy transfer cask with inserted canister, or where the facility's cask loading area dimensions or spatial constraints prevent the placement of a traditional large-sized high-capacity transfer cask.

Improvements in the traditional transfer cask design to extend the applicability and versatility of transfer casks which overcomes the foregoing crane capacity and spatial constraint situations noted above are desired.

### SUMMARY OF THE INVENTION

The application discloses apparatuses, systems, and methods for manufacturing and operating a radiation shielding apparatus for transferring spent nuclear fuel. In one aspect of the invention, a radiation shielding cask apparatus comprises a cask body, a bottom lid detachably, and a plurality of canister support elements. The cask body defines a cavity configured to receive a canister containing spent nuclear fuel. The bottom lid is detachably coupled to the cask body to enclose a bottom end of the cavity. The plurality of canister support elements couple to a bottom portion of the cask body and are alterable between two states. The first state is a canister support state in which the canister support elements protrude into the cavity, support the canister, and prohibit the canister from being removed from the cavity via the bottom end of the cavity. The second state is a canister unloading state in which the canister support elements are retracted and allow the canister to be removed from the cavity via the bottom end of the cavity when the bottom lid is removed from the cask body.

In another aspect, the radiation shielding cask comprises a cask body and a bottom lid. In this aspect, the cask body defines a cavity configured to receive a canister containing spent nuclear fuel and comprises a plurality of shield rings arranged in a stacked assembly. Adjacent ones of the shield rings in the stacked assembly are coupled to each other. The bottom lid is detachably coupled to the cask body to enclose a body end of the cavity.

In another aspect, the radiation shielding cask comprises a cask body, neutron absorbing material, and a bottom lid. The cask body defines a cavity configured to receive a canister containing spent nuclear fuel. The cask body comprises a plurality of axially-extending neutron poison passageways. Each of the axially-extending neutron poison passageways have a circular transverse cross-sectional profile, and the axially-extending neutron poison passageways are arranged so that a radial line extending from a central axis of the cavity to an outer surface of the cask body without passing through one of the axially-extending neutron poison passageways does not exist at an axial height of the spent nuclear fuel in the cavity. The neutron absorbing material is disposed in the axially-extending neutron poison passageways. The bottom lid is detachably coupled to the cask body to enclose a bottom end of the cavity.

In another aspect, the radiation shielding cask apparatus comprises a cask body and a bottom lid. In this aspect, the cask body comprises a cavity, a plurality of axially-extending neutron poison passageways, a plurality of axially-extending gamma blocker passageways, neutron absorbing components, an gamma absorbing components. The cavity is configured to receive a canister containing spent nuclear fuel and extending along a central axis. The plurality of axially-extending neutron poison passageways are located in an outer peripheral region of the cask body. The plurality of axially-extending gamma blocker passage ways are located in an inner peripheral region of the cask body. The neutron absorbing components are disposed in at least some of the axially-extending neutron poison passageways. The gamma absorbing components are disposed in at least some of the axially-extending gamma blocker passageways. The bottom lid is detachably coupled to the cask body to enclose a bottom end of the cavity.

In another aspect, the disclosed invention relates to a method of transferring a canister containing high level radioactive waste from a radiation shielding cask apparatus to a secondary containment structure. The method comprises at least four steps. In the first step comprises positioning the radiation shielding cask apparatus above the secondary containment structure, the radiation shielding cask apparatus comprising a cask body defining a cavity and a bottom lid coupled to the cask body to enclose a bottom end of the cavity, the canister located within the cavity and resting atop and supported by a plurality of canister support elements coupled to the cask body. The second step comprises removing the bottom lid of the radiation shielding cask apparatus from the cask body to open the bottom end of the cavity. The third step comprises retracting the canister support elements to a position in which the canister support elements no longer obstruct the bottom end of the cavity. The fourth step comprises lowering the canister from the cavity of the radiation shielding cask apparatus into a receiving cavity of the secondary containment structure.

In another aspect, the invention relates to a method of manufacturing a radiation shielding cask apparatus. The method comprises at least three steps. The first step comprises forming a plurality of middle shielding rings. Each of the middle shielding rings comprises a ring cavity, a central ring axis, and a plurality of axially-extending neutron poison passageways. The second step comprises inserting neutron absorbing components into the axially-extending neutron poison passageways of each of the middle rings. The third step comprises stacking the middle shielding rings and welding the middle shielding rings together to form a cask body having a cavity collectively formed by the ring cavities.

In another aspect, the method for manufacturing a radiation shielding cask apparatus comprising at least three steps. The first step comprises a cask body having a central cavity configured to receive a canister containing high level radioactive waste, the cavity extending along a central axis. The second step comprises forming a plurality of radially-extending passageways in a bottom end of the cask body from an outer surface of the cask body to an inner surface of the cask body. The third step comprises movably mounting canister support elements in the radial extending passageways so that the canister support elements can be altered between a canister support state and a canister unloading state.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The features of the exemplary embodiments of the present invention will be described with reference to the following drawings, where like elements are labeled similarly, and in which:

FIG. 1 is a top perspective view of a radiation shielding cask apparatus having a plurality of canister support elements;

FIG. 2 is a bottom perspective view of the radiation shielding cask apparatus of FIG. 1;

FIG. 3 is an enlarged perspective view of the radiation shielding cask apparatus of FIG. 1 focusing on one of the canister support elements;

FIG. 4 is an enlarged perspective view of the cask of FIG. 1 with a cover of a canister support element removed;

FIG. 5 is a perspective view of a cavity defined by the cask of FIG. 1 with the support elements in an extended, canister support state;

FIG. 6 is a cross-sectional view showing one of the canister support elements of FIG. 1;

FIG. 7 is an enlarged cross-sectional view of the canister support element of FIG. 6 in the canister support state;

FIG. 8 is an enlarged cross-sectional view of the canister support element of FIG. 6 in a retracted, canister unloading state;

FIG. 9 is top perspective view of a spindle of the canister support element of the radiation shielding cask of FIG. 1;

FIG. 10 is a top perspective view of a sheath of the canister support element of the radiation shielding cask of FIG. 1;

FIG. 11 is a top perspective view of a shield ring which comprises a portion of the radiation shielding cask of FIG. 1;

FIG. 12 is an enlarged top perspective view of the shield ring of FIG. 11;

FIG. 13 is an enlarged top cross-sectional view of radiation shielding cask apparatus of FIG. 1;

FIG. 14 is a cut-away perspective view of the radiation shielding cask of FIG. 1;

FIG. 15 is an enlarged cut-away perspective view of the radiation shielding cask of FIG. 1;

FIG. 16 is an illustration of a method of transferring a canister containing high level radioactive waste from a radiation shielding cask apparatus to a secondary containment structure;

FIG. 17 is an illustration of a method of transitioning a canister support element between a canister support state and a canister unloading state;

FIG. 18 is an illustration of positioning the radiation shielding cask apparatus above a secondary containment structure; and

FIG. 19 is an illustration of lowering the radiation shielding cask apparatus onto the secondary containment structure;

All drawings are schematic and not necessarily to scale. Parts given a reference numerical designation in one figure may be considered to be the same parts where they appear in other figures without a numerical designation for brevity unless specifically labeled with a different part number and described herein.

### DETAILED DESCRIPTION OF THE EMBODIMENTS

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

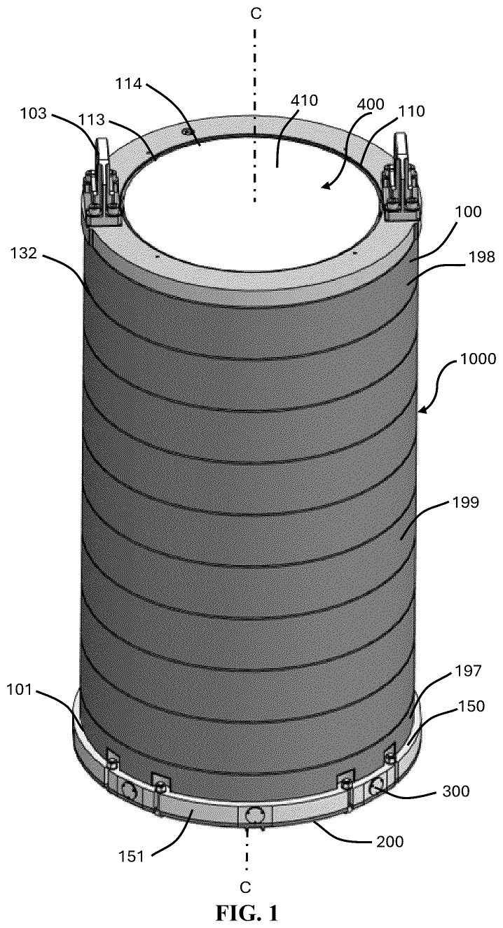

FIG. 1 shows a radiation shielding cask apparatus 1000 which is configured to transfer a canister 400 containing high levels of radioactive water from a cooling pool to a secondary containment structure 500. The radiation shielding cask apparatus 1000 is configured to operate in both a dry or a wet environment. The radiation shielding cask apparatus 1000 is constructed with the features described herein to achieve an As-Low-As-Reasonably-Achievable (ALARA) radiation dose while containing a canister 400 containing high levels of radioactive material. In one embodiment, the radiation shielding cask apparatus 1000 comprises a cask body 100, a bottom lid 200, and a plurality of canister support elements 300. The structure of the radiation shielding cask apparatus 1000 will be described in further detail below.

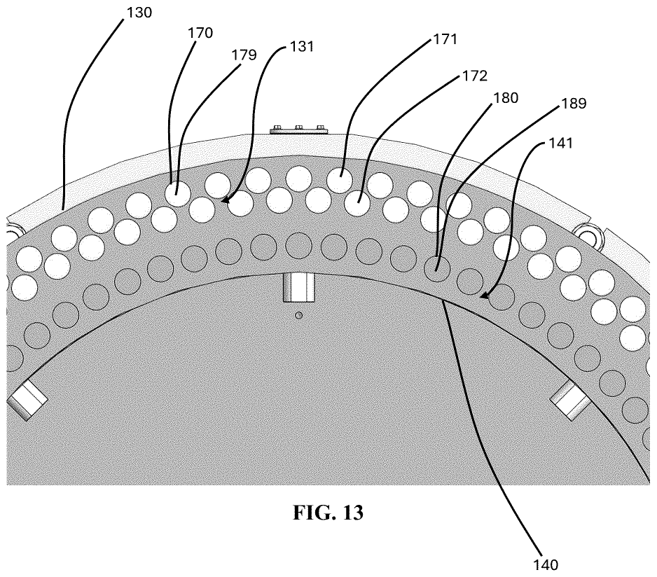

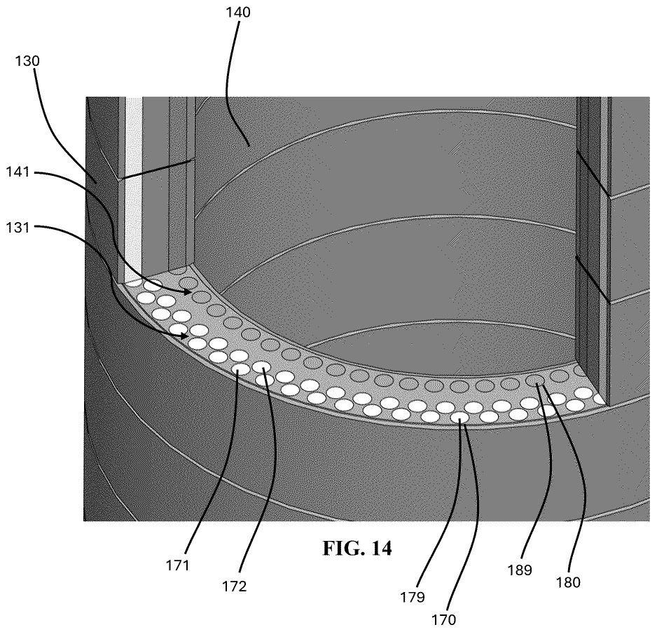

Referring to FIGS. 1-3 and 13-14 the cask body 100 is generally a prismatic structure which is preferably cylindrical. However, the cask body 100 may be any prismatic shape configured to accommodate the canister 400 such as a rectangular or hexagonal prism. The cast body is preferably formed from stainless steel or aluminum but can be manufactured from any other suitable material. However, the invention is not limited to only the materials listed herein, and the cask body 100 may be formed of any suitable material for storing spent nuclear fuel.

The cask body 100 defines a cavity 110 configured to receive a canister 400 containing spent nuclear fuel. The cavity 110 further defines a central axis C-C, and the cask body 100 may comprise a plurality of passageways 120 extending from an outer surface 130 of the cask body 100 to an inner surface 140 of the cask body 100. Each of the plurality of passageways may be bored through the cask body as a through hole, a counter bored hole, a counter sunk hole, or any other type of machined hole. The cask body 100 may further comprise an outer peripheral region adjacent 131 to the outer surface of the cask 130 and an inner peripheral region 141 adjacent to the inner surface 140 of the cask body 100. The plurality of passageways 120 comprises a minimum of four passageways 120 to fully support the canister 400, but may comprise six passageways 120, eight passageways 120, or more depending on the dimensions and weight of the canister 400. Each of the plurality of passageways 120 are arranged circumferentially in the cavity 110 at equal angular spacing to provide a stable staging surface for the canister 400. The angular spacing may be 90°, 60°, 45°, 30°, or any other angular spacing to ensure that the plurality of passageways 120 are equally spaced from one another regardless of the number of passageways 120.

Describing the cavity 110 in further detail, an inner diameter of the cavity 110 is preferably greater than an outer diameter of the canister 400 to form an annular gap 113 or annulus between the inner surface 140 of the cask body 100 and an outer surface 410 of the canister 400 to enable the free insertion or withdrawal of the canister 400 from the cavity 110.

Referring back to the shape of the cask body 100, the cask body 100 may further comprise an annular seal 160 configured to be positioned at a top end 114 of the annular gap 113 formed between the canister 400 and the inner surface 140 of the cask body 100 to hermetically seal the top end 114 of the annular gap 113 the outer surface 130 of the cask body 100 may be equipped with axially disposed grooves 131 to increase the cask's heat dissipation capability, if needed. The outer surface 130 of the cask body 100 may optionally be equipped with axial spines to further increase the heat rejection capacity of the radiation shielding cask apparatus 1000 further.

The cask body 100 may further comprise a bottom flange 150 coupled to the bottom end 101 of the cask body 100. The bottom flange 150 comprises a plurality of channels 155 formed into an outer sidebody 151 of the bottom flange 150. In embodiments where the cask body comprises a bottom flange 150, the bottom flange 150 comprises the plurality of passageways 120 and the outer sidebody 151 forms a portion of the outer surface 130 of the cask body 100.

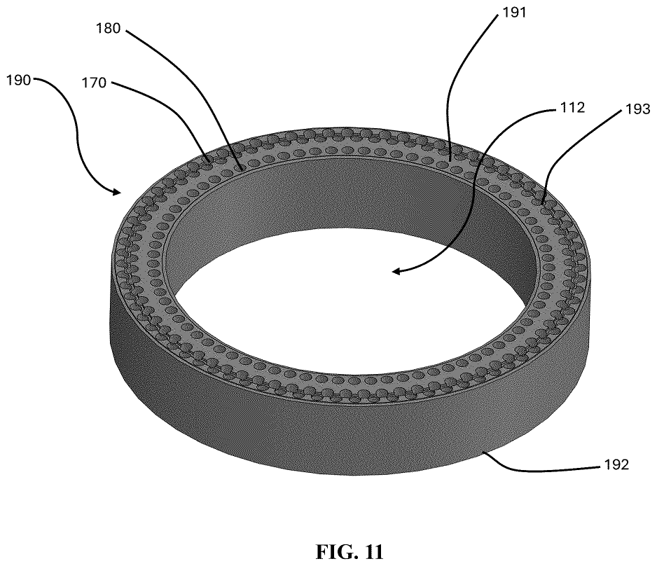

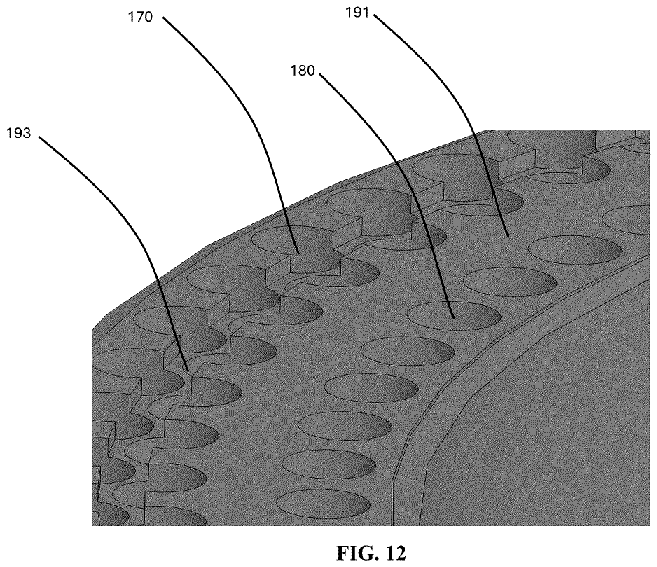

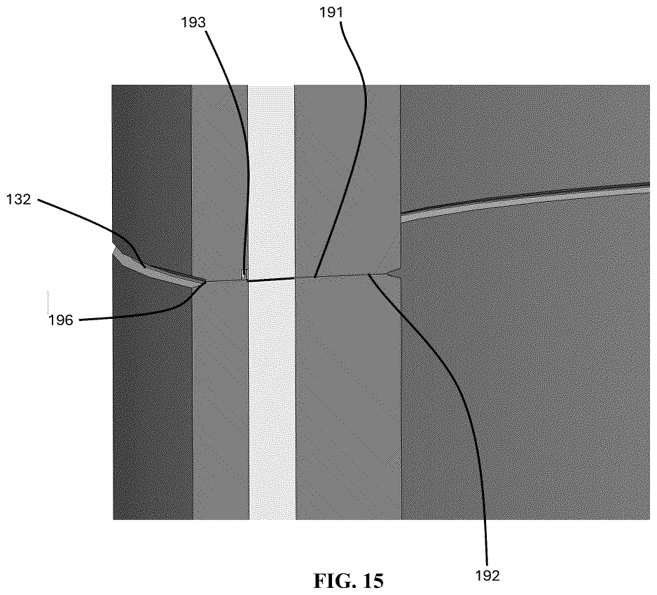

Referring to FIGS. 11-15 , the cask body 100 may further comprise a plurality of axially-extending neutron poison passageways 170. Neutron absorbing material 179 is disposed in at least some of the axially-extending neutron poison passageways. This neutron material 179 may be water or a hydrogen-rich polymeric material such as HOLTITE™, but the invention is not limited to only the materials listed herein. Each of the axially-extending neutron poison passageways 170 preferably have a circular transverse cross-sectional profile, but may have a transverse cross-sectional profile shaped to accommodate any shape of the neutron absorbing material 179. The plurality of axially-extending neutron poison passageways 170 may be arranged so that a radial line that extends from the central axis C-C of the cavity 110 to the outer surface 130 of the cask body 110 without passing through one of the axially-extending neutron poison passageways 170 does not exist.

The axially-extending neutron poison passageways may comprise a first set of axially-extending neutron poison passageways 171 and a second set of axially-extending neutron poison passageways 172. The first set of axially-extending neutron poison passageways 171 are located a first radial distance from the central axis C-C of the cavity 110, and the second set of axially-extending neutron poison passageways 172 are located a second radial distance from the central axis C-C of the cavity 110. The second distance is preferably less than the first distance. The first set of axially-extending neutron poison passageways 171 may be angularly offset from the second set of axially-extending neutron poison passageways 172 such that no one first axially-extending neutron passageway 171 is radially aligned with a second axially-extending neutron passageway 172. Each axially-extending neutron poison passageways of the first set 171 are equally spaced from one another and the axially-extending neutron poison passageways of the second set 172 are equally spaced from one another. Furthermore, the axially-extending neutron poison passageways of the first set 171 have a first transverse cross-sectional diameter and the axially-extending neutron poison passageways of the second set 172 have a second transverse cross-sectional diameter, the second transverse cross-sectional diameter being smaller than the first transverse cross-sectional diameter.

The cask body 100 may further comprise a plurality of axially-extending gamma blocker passageways 180 and gamma absorbing material 189 disposed in at least some of the axially-extending gamma blocker passageways 180. The gamma absorbing material 189 is a high density material such as lead or copper, but the invention is not limited to only the materials listed herein. The plurality of axially-extending gamma blocker passageways 180 are preferably located in the inner peripheral region 141 of the cask body 100.

The outer diameter of the cask body 100 and the number & size of the axially extending gamma blocker passageways 180 can be adjusted to maximize the weight of the radiation shielding cask apparatus 1000 within the capacity limit of an individual nuclear plant's crane, the size of the desired cask laydown area in the pool, and the slab weight holding capacity of the laydown surfaces where the cask will be staged. Thus, the cask body 100 design can be optimized within the constraints of the nuclear plant using the anatomical design platform presented in this disclosure.

Referring generally to FIGS. 1-2 and 11-15, in some embodiments the cask body 100 may comprise a plurality of shield rings 190 arranged in a stacked assembly. Each of the plurality of shield rings 190 is preferably monolithically constructed and manufactured as a single, forged piece. However, other product forms such as castings and rolled plates can also be used to accommodate manufacturing and radiation shielding needs.

Each shield ring 190 comprises a top surface 191, a bottom surface 192, and a circumferential channel 193 formed in the top surface 191. Outer surfaces and inner surfaces of each shield ring 190 respectively form portions of the outer surface 130 and the inner surface 140 of the case body 100. The top surfaces 191 of each shield ring 190 are configured to interface with the bottom surfaces 192 of adjacent shield rings 190 to enable the shield rings 190 to be stacked together. The circumferential channel 193 formed in the top surface of each of the plurality of shield rings is in spatial communication with each of axially-extending neutron poison passageways 170 and may serve as a pressure relief channel. When arranged in a stacked assembly, adjacent ones of the shield rings 190 are coupled to each other. This coupling may be achieved through by welding each adjacent shield ring 190 to each other along both an inner circumference interface 194 and an outer circumference interface 195. Welding the plurality of shield rings 190 in this manner forms edge joints 196 between each adjacent shield ring 190. The depth of the edge joints 196 should be preferably at least ¾ inches deep groove welds, or another other groove welds typical for such applications.

An inner diameter of each shield ring 190 corresponds to the case body's 100 inner diameter and likewise larger than the canister's 400 outer diameter. The inner diameter of each shield ring 190 is preferably at least ⅜ inches larger than the canister's 400 outer diameter to facilitate the insertion and removal of the canister 400. However, the inner diameter of the stacked assembly of shield rings 190 may be varied to accommodate canisters 400 of various sizes. The top surface 191 and the bottom surface 192 of the shield rings may be machined differently to accommodate ancillary hardware at the two ends of the cask. Further, the total number of shield rings and resulting height of the case body 100 may be selected as to best accord with manufacturing needs. However, the height of the stacked assembly should be such that the canister 400 is enveloped by the case body 100 for most or all of its entire height.

The plurality of shield rings 190 may further comprise a lowermost shielding ring 197, an uppermost shielding ring 198, and a plurality of middle shielding rings 199. Each of the middle shielding rings 199 may further comprise the plurality of axially extending neutron poison passageways 170 and the plurality of axially-extending gamma blocker passageways 180 described above. For each of the middle shielding rings 199, the circumferential channel 193 is also in spatial communication with each of the axially-extending neutron poison passageways 170 of an adjacent one of the middle shielding rings 199 in the stacked assembly that is above the middle shielding ring 199. Further, each of the neutron absorbing components 170 may nest entirely within a singular one of the middle shielding rings 199. Alternatively, the neutron absorbing components 170 may span multiple of the middle shielding rings 199.

The uppermost shielding ring 198 may comprise one or more pressure relief valves 109 that are in spatial communication with the axially-extending neutron poison passageways 170 of the middle shielding rings 199 to allow off-gasses from the neutron absorbing components 179 to escape upon a predetermine pressure being reached. The one or more pressure relief valves 109 may be operatively coupled to the circumferential channel 193 of a top one of the middle shielding rings 199.

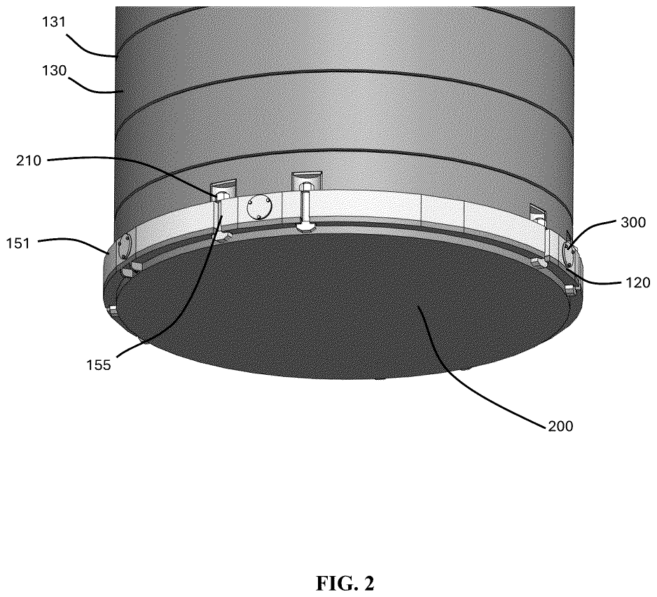

Referring to specifically FIG. 2, the bottom lid 200 will be described in further detail. The bottom lid 200 is preferably circular but can be any other shape that is adapted to match the prismatic shape of the case body 100. The bottom lid 200 detachably coupled to the cask body 100 to enclose a bottom end 111 of the cavity 110. When the bottom lid 200 is attached to the cask body 100, a hermetic seal is formed between the bottom lid 200 and the cask body 100. The bottom lid is detachably coupled to a bottom end 101 of the cask body 100 via a plurality of fasteners 210. The fasteners 210 being pivot bolts nesting within the channels of the cask body 100. The fasteners may further be quick connect/disconnect fasteners to minimize the duration of human activity near the radiation shielding cask apparatus 1000.

The radiation shielding cask apparatus 1000 may optionally comprise a top lid to fully enclose the canister 400 and hermetically seal the cavity 110. A lead snake or similar pliable radiation blocker may be used to confine an annular space at a top of the cask body 100 between the canister 400 and the top lid. The cask body 100 further be equipped with a set of trunnions 103 coupled to a top end 102 of the case body 100 configured to engage with a crane arm to lift the radiation shielding cask apparatus 1000.

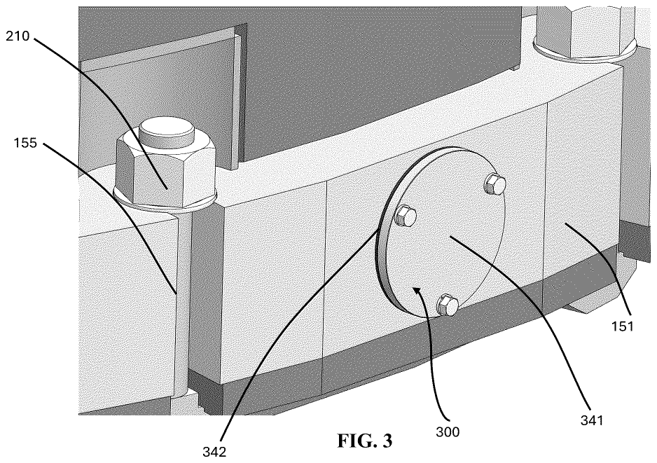

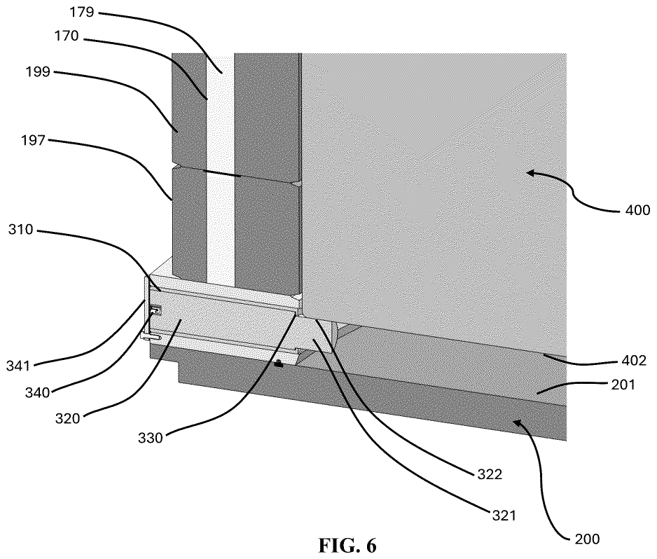

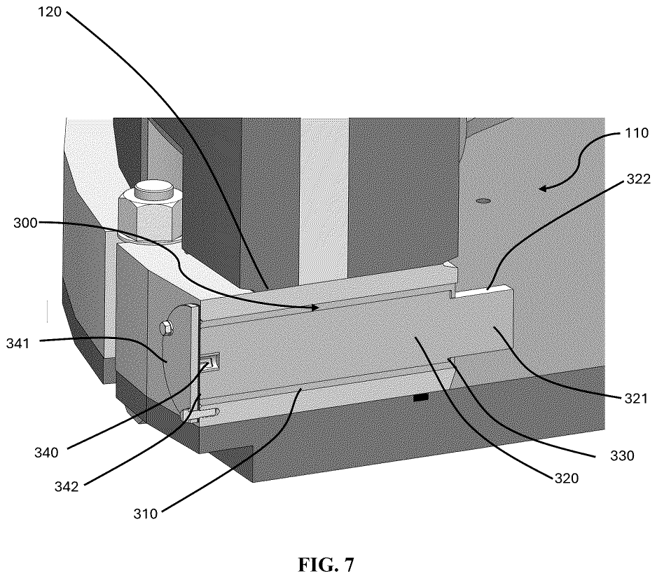

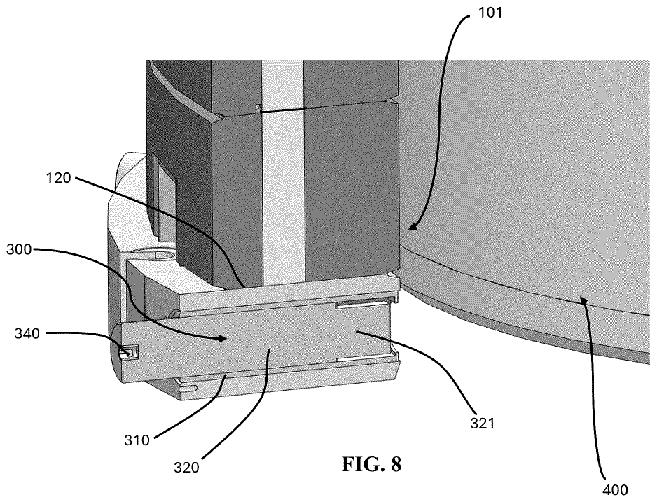

Referring now to FIGS. 3-10 , the plurality of canister support elements 300 will be discussed in further detail. The plurality canister support elements 300 may be moveably coupled within the plurality of passageways 120. In the illustrated embodiment, the plurality canister support elements are slidably coupled within the plurality of passageways 120 allowing them to translate bidirectionally. The invention is not limited to just the illustrated embodiment, however. For instance, each of the plurality of canister support elements 300 may be threadedly engaged with the plurality of passageways 120 to allow the canister support elements 300 to rotate in order to translate bidirectionally. Further, the canister support elements 300 may be hinged within the plurality passageways 120. The canister support elements 300 may be rotatable such that they rotate out of the plurality of passageways 120 into the cavity 110. In other embodiments, the canister support elements 300 may be moveably coupled within the plurality of passageways 120 with a spring. In still other embodiments, the plurality of canister support elements 300 may be moveably coupled to the plurality of passageways through pneumatic or hydraulic pumps. Alternatively, the plurality of canister support elements 300 may be moveably coupled via any combination of the above-mentioned configurations.

The plurality of canister support elements 300 are alterable between two states: (1) a canister support state; and (2) a canister unloading state. In the canister support state, the canister support elements 300 protrude into the cavity 110 to support the canister 400 and prohibit the canister 400 from being removed from the cavity 110 via the bottom end 111 of the cavity 110. Preferably, only a distal portion 321 of each of the canister support elements 300 protrude from the inner surface 140 of the cask body 100 and into the cavity 110. The canister support elements 300 preferably protrude at least 1 inch into the cavity 110 but may protrude more than 1 inch to better support the canister 400. In the canister unloading state, the canister support elements 300 are retracted and allow the canister 400 to be removed from the cavity 110 via the bottom end 111 of the cavity 110 when the bottom lid 200 is removed from the cask body 110. Further the distal portion 321 of the canister support element 300 may at least partially nested within the passageway 120. Each of the canister support elements 300 is movably mounted within one of the passageways 120 to be moved between the support state and the unloading state. The load bearing capacity of the canister support elements 300 preferably exceeds 10 times the weight of a typical loaded Canister 400.

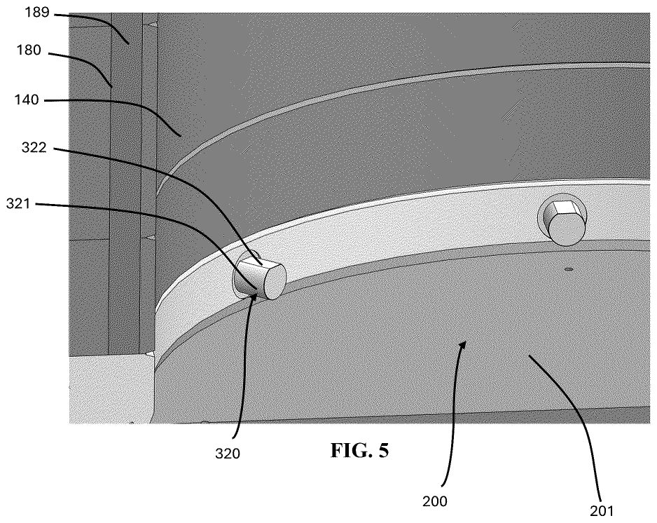

Referring specifically to FIG. 5, the canister support elements 300 may be located adjacent to a top surface 201 of the bottom lid 200 that forms a floor of the cavity 110 when the bottom lid 200 is attached to the cask body 100. Preferably, the canister support elements 300 support the canister 400 above the top surface 201 so that a gap exists between a bottom surface 402 of the canister 400 and the floor of the cavity 110.

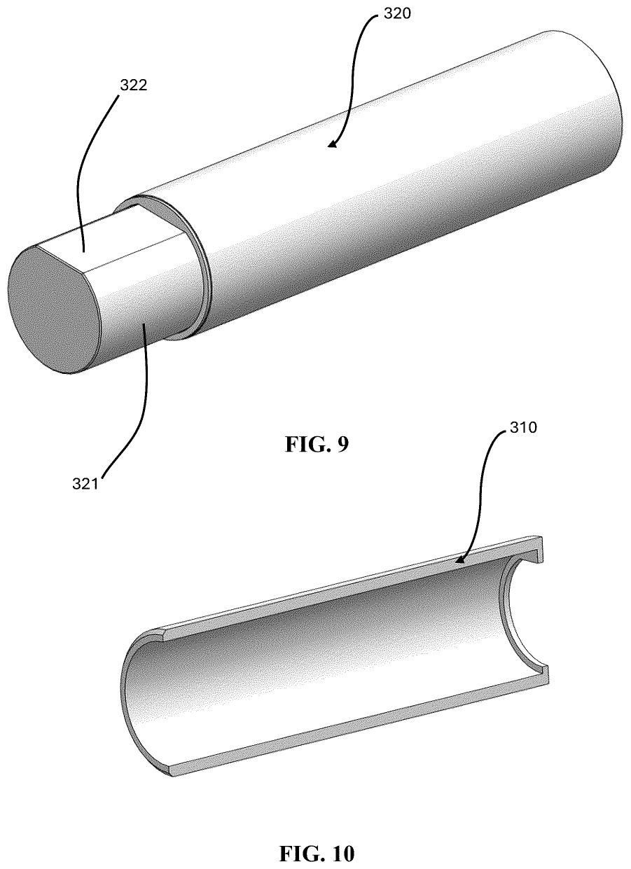

Referring specifically to FIGS. 9-10 , each of the canister support elements 300 may comprise a sleeve 310 and a spindle 320 movably mounted within the sleeve 310 to protect against excessive wear. In other embodiments, the sleeve 310 may be entirely omitted and the spindle 320 may be moveably mounted within the plurality of passageways 120. The spindle 320 may be slidably mounted within the sleeve 310 or alternatively the sleeve 310 and spindle 320 may be threaded to allow the spindle 320 to be rotatably mounted within the sleeve 310. The spindle 320 is preferably cylindrical to improve manufacturability. However, the spindle can also take on other prismatic shapes such as a rectangular prism based on the engineering and manufacturability needs. The spindle 320 is preferably made of a high strength, high ductility, and high fracture strength material such as precipitation hardened stainless steel heat treated to 1100 F. However, other materials that exhibit high strength, high ductility, and a high fracture strength may be used as well such as other stainless steel or aluminum alloys. The sleeves 310 preferably have high-strength and smooth walls 311. Both the spindle 320 and sleeve 310 material are also ideally corrosion resistant.

The spindle 320 comprises the distal portion 321 of the canister support element 300 and the distal portion 320 may comprise a flat upper surface 322 for contacting and supporting a bottom surface of the canister 400. Each spindle 310 is slidably mounted within the one of the sleeves 320 to be slidably translated between the support state and the unloading state. When the spindles 320 are in the canister support state, the passageways 120 are hermetically sealed to the external environment. In the canister support state, the passageways 120 may be sealed against water leakage at a pressure of at least one atmosphere gage. The canister support element 300 may further comprise a gasket between spindle 320 and the sleeve 310 which is compressed when the spindle is in the support state to prevent leakage of water from the cavity 110 to the external environment. Further, the canister support elements 300 are machined to have a sliding fit and so that a tortuous interface 330 preferably exists between the canister support element 300 and the cask body 100 that prevents outward streaming of radiation from the canister to the external environment.

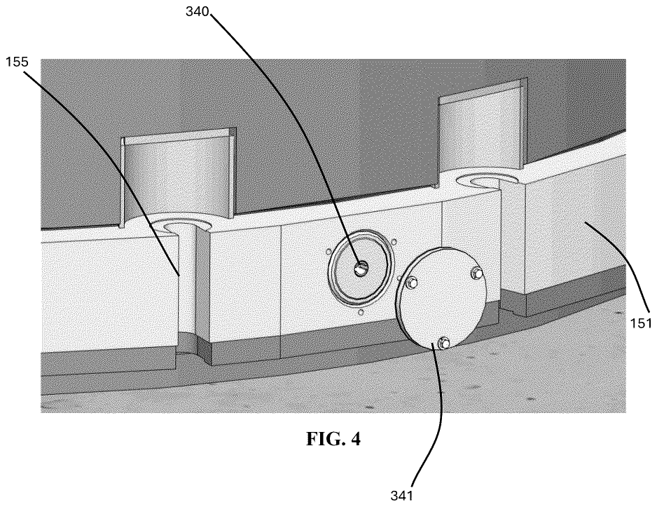

Referring to FIGS. 3-4 , the cask body 100 may further comprise a plurality of locking elements 340 associated with the canister support elements 300. Each of the locking elements 340 alterable between: (1) a first state in which an associated one of the cask support elements 300 is locked in the canister support state; and (2) a second state in which the associated one of the cask support elements 300 can be altered from the canister support state to the canister unloading state. Each of the locking elements 340 may comprise a closure plate 341 that is detachably coupled to the outer surface 130 of the cask body 100. Furthermore, each of the locking elements 340 may further comprise a seal 342 located between the closure plate 341 the outer surface 130 of the cask body 100 that is compressed in the first state to hermetically seal the canister support elements 300.

In embodiments where the case body 100 comprises a plurality of shield rings 190, the canister support elements 300 are mounted to the lowermost shielding ring 197 in the stacked assembly. In such embodiments, the canister support elements 300 are circumferentially arranged in a spaced-apart manner about a central axis of the cavity to correspond to the arrangement of the passageways 120 described above.

An example process or method of manufacturing a radiation shielding cask apparatus 1000 will be briefly described and summarized below.

In one embodiment, the method includes at least three steps. In the first step in this method comprises forming the plurality of middle shielding rings 199, each of the middle shielding rings 199 comprising a ring cavity 112, the central axis C-C, and the plurality of axially-extending neutron poison passageways 170. The lowermost shielding ring 197 and top shielding ring 198 may be formed at this step as well. This step may further comprise forming the axially extending gamma blocker passageways 180 in the middle shielding ring 199 in the arrangements described above.

The second step in this method comprises inserting the neutron absorbing components 179 into the axially-extending neutron poison passageways 170 of each of the middle shielding rings 199. If forming axially extending gamma blocker passageways 180 is included in the first step, the second step further comprises inserting the gamma absorbing components 189 into the axially-extending gamma blocking passageways 180 of each of the middle shielding rings 199.

The third step in this method comprises stacking the middle shielding rings 199 and welding the middle shielding rings 199 together to form the cask body 100 with the cavity 110 collectively formed by the ring cavities 112. This step may further comprise welding adjacent ones of the middle shield rings 199 to each other along the inner circumference interface 194 and the outer circumference interface 195. If the uppermost and lowermost shielding rings 198, 197 are formed during the first step, the uppermost and lowermost shielding rings 198, 197 are welded to the middle shielding rings 199 to form the cask body 100.

In another embodiment of a method of manufacturing the radiation shielding cask apparatus 1000, the cask body 100 is formed of a monolithic component. This method may comprise the steps described above and further comprise drilling a plurality of radially-extending passageways 120 in the lowermost shielding ring 197 that extend from the outer surface 130 of the lowermost shielding ring 197 to the inner surface 140 of the lowermost shielding ring 197. This step may further comprise movably mounting the canister support elements 300 in the radial extending passageways 120 so that the canister support elements 300 can be altered between a canister support state and an unloading state. This step may further comprise forming circumferential channels 193 in the uppermost shielding ring 198 that are in spatial communication with the axially-extending neutron poison passageways 170 and operably coupling the pressure relief valves 109 to the circumferential channels 193.

In another example of manufacturing a radiation shielding cask apparatus 1000, the method comprises first forming a cask body 100 having a central cavity 110 configured to receive a canister 400 containing high level radioactive waste, the cavity 110 extending along a central axis C-C. Subsequently, the method comprises forming a plurality of radially-extending passageways 120 in a bottom end 101 of the cask body 100 from the outer surface 130 of the cask body 100 to the inner surface 140 of the cask body 100. Subsequently to that, the method comprises movably mounting the canister support elements 300 in the radial extending passageways 120 so that the canister support elements 300 can be altered between a canister support state and a canister unloading state.

In a further embodiment of this method of manufacturing, the radiation shielding cask apparatus 1000 may additionally comprise covering openings of the radially extending passageways 120 to seal the radially extending passageways and lock the canister support elements 300 in the canister support state. In such an embodiment, when the canister support elements 300 are in the canister support state the canister support elements protrude into the cavity 110, support the canister 400, and prohibit the canister 400 from being removed from the cavity 110 via the bottom end of the cavity 110. When the canister support elements 300 are altered to in the canister unloading state, the canister support elements 300 are retracted and allow the canister 400 to be removed from the cavity 110 via the bottom end 111 of the cavity 110 when the bottom lid 200 is removed from the cask body 100. The method may further comprise detachably coupling a bottom lid 200 to the bottom end 101 of the cask body 100 to seal the bottom end 111 of the cavity 110.

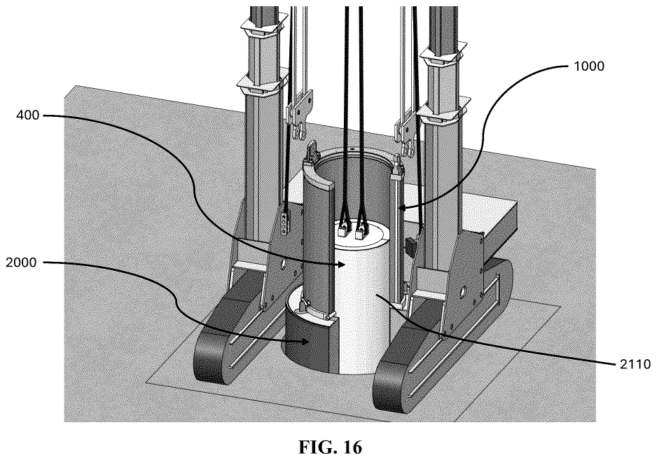

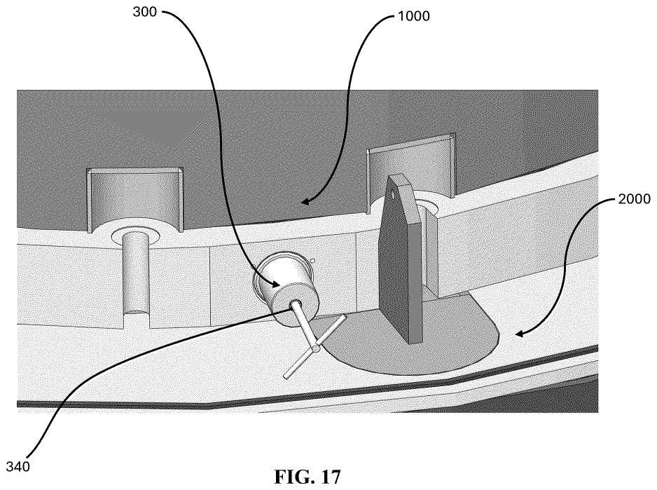

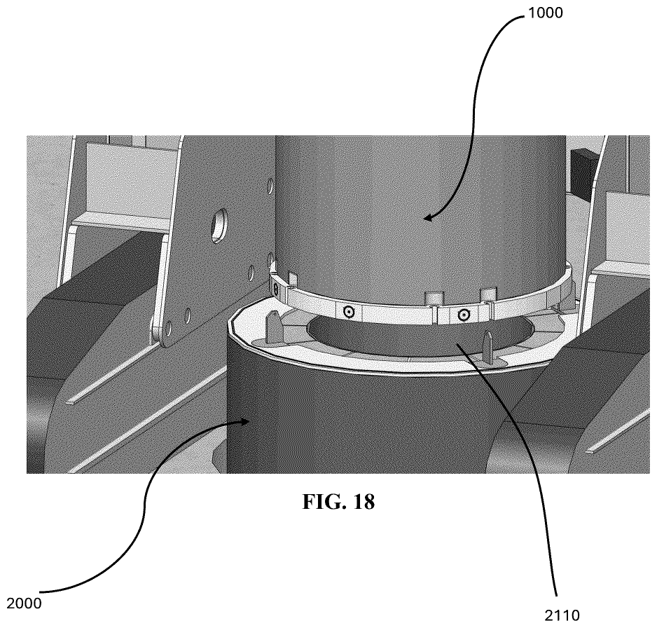

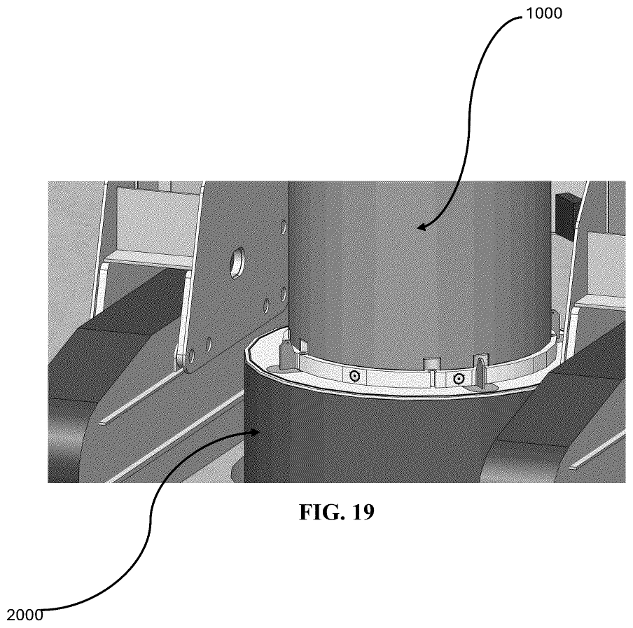

Referring to FIGS. 16-19 , an example process or method for transferring the canister 400 containing high level radioactive waste from a radiation shielding cask apparatus to a secondary containment structure 2000 will be briefly described and summarized.

In one embodiment, the method includes at least four steps. The first step comprises positioning the radiation shielding cask apparatus 1000 above the secondary containment structure 2000, the radiation shielding cask apparatus 1000 comprising the cask body 100 as described in the paragraphs above where the bottom lid 200 is coupled to the cask body 100 and encloses the bottom end 111 of the cavity 110. The canister 400 is located within the cavity 110 of the cask body 100 and resting atop and supported by the plurality of canister support elements 300. The bottom end 111 of the cavity 110 and the canister 400 may further be hermetically sealed. This step may further require that the canister 400 be positioned within the cavity 100 of the radiation shielding cask apparatus 1000 to form the annular gap 113 between the outer surface 401 of the canister 400 and the inner surface 140 of the cask body 100, and the canister support elements support 300 the canister 400 above the top surface 201 of the bottom lid so that a gap exists between top surface 201 of the bottom lid 200 and the bottom surface 402 of the canister 400. The canister support elements 300 may also then be locked in place supporting the canister 400 to prevent inadvertent retracting of the canister support elements 300 during this step.

The first method step may further comprise positioning the canister 400 in the cavity 110 of the radiation shielding cask apparatus 1000. The top end 114 of the cavity 110 being open, the annular seal 160 positioned between the canister 400 and the cask body 100 to hermetically seal the top end 114 of the annular gap 113 located between the canister 400 and the cask body 100 to the ingress of water, the bottom end 111 of the cavity 110 also being hermetically sealed to the ingress of water. Prior to positioning the radiation shielding cask apparatus 1000 above the secondary containment structure 2000, the radiation shielding cask apparatus 1000 and the canister 400 may be then submerged in a pool of water, the canister 400 loaded with spent nuclear fuel rods, and the top end 114 of the cavity 100 may be closed with a canister lid. Subsequently to that, the radiation shielding cast apparatus 1000 and the canister 400 are removed from the pool of water.

The second method step may comprise removing the bottom lid 200 of the radiation shielding cask apparatus 1000 from the cask body 100 to open the bottom end 111 of the cavity 110. This step may further comprise lowering the radiation shielding cask apparatus 1000 while the canister 400 remains supported by the canister support elements 300 until the radiation shielding cask apparatus 1000 contacts and is positioned atop the secondary containment structure 2000 in a stacked arrangement where the cavity 110 and a receiving cavity 2110 of the secondary containment structure 2000 are axially aligned with one another.

The third step may comprise retracting the canister support elements 300 to a position in which the canister support elements 300 no longer obstruct the bottom end 111 of the cavity 110. This step may further comprise lifting the canister 400 to remove the canister's 400 weight from the canister support elements 300 and retracting the canister support elements 300 while the canister's 400 weight is removed. The canister support elements 300 may then be withdrawn radially outward until the canister support elements 300 no longer obstruct the bottom end 111 of the cavity 110 to allow the canister 400 to pass therethrough. In this step, the canister support elements 300 may also be retracted from a position in which the distal portion 321 of the canister support element 300 protrudes from the inner surface 140 of the cask body 100 and into the cavity 110 to the position in which the canister support element 300 no longer protrude from the inner surface 140 of the cask body 100. If the canister support elements 300 were locked in place during the first step, the third step further comprises unlocking the canister support elements 300 and then retracting the canister support elements 300.

The fourth step may comprise lowering the canister 400 from the cavity 110 of the radiation shielding cask apparatus 1000 into the receiving cavity 2110 of the secondary containment structure 2000. The secondary containment structure 2000 is preferably selected from a group consisting of a storage cask, a transfer cask, and a ventilated storage unit, but can be any structure suited for long-term storage of spent nuclear fuel.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

### EXEMPLARY CLAIM SET

Exemplary claim 1. A radiation shielding cask apparatus comprising: a cask body defining a cavity configured to receive a canister containing spent nuclear fuel; a bottom lid detachably coupled to the cask body to enclose a bottom end of the cavity; and a plurality of canister support elements coupled to a bottom portion of the cask body and alterable between: (1) a canister support state in which the canister support elements protrude into the cavity, support the canister, and prohibit the canister from being removed from the cavity via the bottom end of the cavity; and (2) a canister unloading state in which the canister support elements are retracted and allow the canister to be removed from the cavity via the bottom end of the cavity when the bottom lid is removed from the cask body.

Exemplary claim 2. The radiation shielding cask apparatus according to exemplary claim 1 further comprising: the cask body comprising a plurality of passageways extending from an outer surface of the cask body to an inner surface of the cask body; and each of the canister support elements movably mounted within one of the passageways to be moved between the support state and the unloading state.

Exemplary claim 3. The radiation shielding cask apparatus according to exemplary claim 2 wherein, in the support state, a distal portion of each of the canister support elements protrude from the inner surface of the cask body and into the cavity; and wherein, in the unloading state, the distal portion of the canister support element is at least partially nested within the passageway.

Exemplary claim 4. The radiation shielding cask apparatus according to exemplary claim 3 wherein, for each of the canister support elements, the distal portion comprises a flat upper surface for contacting and supporting a bottom surface of the canister.

Exemplary claim 5. The radiation shielding cask apparatus according to any one of exemplary claims 2 to 4 wherein each of the canister support elements is slidably mounted within the one of the passageways to be slidably translated between the support state and the unloading state.

Exemplary claim 6. The radiation shielding cask apparatus according to any one of exemplary claims 2 to 5 wherein when the canister support elements are in the canister support state, the passageways are hermetically sealed to the external environment.

Exemplary claim 7. The radiation shielding cask apparatus according to any one of exemplary claims 2 to 6 wherein, for each of the canister support elements, a tortuous interface exists between the canister support element and the cask body that prevents outward streaming of radiation from the canister to the external environment.

Exemplary claim 8. The radiation shielding cask apparatus according to any one of exemplary claims 1 to 7 wherein each of the canister support elements comprises a spindle.

Exemplary claim 9. The radiation shielding cask apparatus according to any one of exemplary claims 1 to 8 further comprising a plurality of locking elements associated with the canister support elements, each of the locking elements alterable between: (1) a first state in which an associated one of the cask support elements is locked in the canister support state; and (2) a second state in which the associated one of the cask support elements can be altered from the canister support state to the canister unloading state.

Exemplary claim 10. The radiation shielding cask apparatus according to exemplary claim 9 wherein each of the locking elements comprises a closure plate that is detachably coupled to an outer surface of the canister body.

Exemplary claim 11. The radiation shielding cask apparatus according to exemplary claim 10 wherein each of the locking elements further comprises a seal located between the closure plate the outer surface of the cask body that is compressed in the first state.

Exemplary claim 12. The radiation shielding cask apparatus according to any one of exemplary claims 1 to 11 wherein the canister support elements are located adjacent a surface of the bottom lid that forms a floor of the cavity when the bottom lid is attached to the cask body, the canister support elements supporting the canister above the top surface so that a gap exists between a bottom surface of the canister and the floor of the cavity.

Exemplary claim 13. The radiation shielding cask apparatus according to any one of exemplary claims 1 to 12 wherein, when the bottom lid is attached to the cask body, a hermetic seal is formed between the bottom lid and the cask body.

Exemplary claim 14. The radiation shielding cask apparatus according to any one of exemplary claims 1 to 13 wherein the bottom lid is detachably coupled to a bottom end of the cask body via a plurality fasteners.

Exemplary claim 15. The radiation shielding cask apparatus according to exemplary claim 14 wherein the cask body comprises a bottom flange, the bottom flange comprising a plurality of channels formed into an outer sidebody of the bottom flange, the fasteners being pivot bolts nesting within the channels.

Exemplary claim 16. The radiation shielding cask apparatus according to any one of exemplary claims 1 to 15 further comprising an annular seal configured to be positioned at a top end of an annulus formed between the canister and the inner surface of the cask body to hermetically seal the top end of the annulus.

Exemplary claim 17. The radiation shielding cask apparatus according to any one of exemplary claims 1 to 16 wherein the cask body is formed of a metal.

Exemplary claim 18. The radiation shielding cask apparatus according to any one of exemplary claims 1 to 17 further comprising: the cask body comprising a plurality of axially-extending neutron poison passageways; and a neutron absorbing material disposed in at least some of the axially-extending neutron poison passageways.

Exemplary claim 19. The radiation shielding cask apparatus according to exemplary claim 18 wherein each of the axially-extending neutron poison passageways has circular transverse cross-sectional profile.

Exemplary claim 20. The radiation shielding cask apparatus according to any one of exemplary claims 18 to 19 wherein the axially-extending neutron poison passageways are arranged so that a radial line extending from a central axis of the cavity to an outer surface of the cask body without passing through one of the axially-extending neutron poison passageways does not exist.

Exemplary claim 21. The radiation shielding cask apparatus according to any one of exemplary claims 18 to 20 wherein the axially-extending neutron poison passageways comprises: a first set of axially-extending neutron poison passageways arranged in a spaced-apart manner about a first circumference of the cask body that is located a first radial distance from a central axis of the cavity; and a second set of axially-extending neutron poison passageways arranged in a spaced-apart manner about a second circumference of the cask body that is located a second radial distance from the central axis of the cavity, the second distance being less than the first distance.

Exemplary claim 22. The radiation shielding cask apparatus according to exemplary claim 21 wherein the first set of axially-extending neutron poison passageways are angularly offset from the second set of axially-extending neutron poison passageways.

Exemplary claim 23. The radiation shielding cask apparatus according to any one of exemplary claims 21 to 22 wherein the axially-extending neutron poison passageways of the first set are equi-spaced from one another and the axially-extending neutron poison passageways of the second set are equi-spaced from one another.

Exemplary claim 24. The radiation shielding cask apparatus according to any one of exemplary claims 21 to 23 wherein the axially-extending neutron poison passageways of the first set have a first transverse cross-sectional diameter and the axially-extending neutron poison passageways of the second set have a second transverse cross-sectional diameter, the second transverse cross-sectional diameter being smaller than the first transverse cross-sectional diameter.

Exemplary claim 25. The radiation shielding cask apparatus according to any one of exemplary claims 18 to 24 wherein the axially-extending neutron poison passageway are located in an outer peripheral region of the cask body.

Exemplary claim 26. The radiation shielding cask apparatus according to any one of exemplary claims 18 to 25 wherein the axially-extending neutron poison passageways extend a majority of the axial length of the cask body.

Exemplary claim 27. The radiation shielding cask apparatus according to any one of exemplary claims 1 to 26 further comprising: the cask body comprising a plurality of axially-extending gamma blocker passageways; and a gamma absorbing material disposed in at least some of the axially-extending gamma blocker passageways.

Exemplary claim 28. The radiation shielding cask apparatus according to exemplary claim 27 wherein the gamma absorbing material is a high density material.

Exemplary claim 29. The radiation shielding cask apparatus according to any one of exemplary claims 1 to 28 further comprising: the cask body comprising a plurality of shield rings arranged in a stacked assembly; and wherein adjacent ones of the shield rings in the stacked assembly are coupled to each other.

Exemplary claim 30. The radiation shielding cask apparatus according to exemplary claim 29 wherein adjacent ones of the shield rings in the stacked assembly are welded to each other along an inner circumference interface and an outer circumference interface.

Exemplary claim 31. The radiation shielding cask apparatus according to any one of exemplary claims 29 to 30 wherein the canister support elements are mounted to a lowermost one of the shield rings in the stacked assembly.

Exemplary claim 32. The radiation shielding cask apparatus according to any one of exemplary claims 1 to 31 wherein the canister support elements are circumferentially arranged in a spaced-apart manner about a central axis of the cavity.

Exemplary claim 33. A radiation shielding cask apparatus comprising: a cask body defining a cavity configured to receive a canister containing spent nuclear fuel, the cask body comprising a plurality of shield rings arranged in a stacked assembly, wherein adjacent ones of the shield rings in the stacked assembly are coupled to each other; and a bottom lid detachably coupled to the cask body to enclose a bottom end of the cavity.

Exemplary claim 34. The radiation shielding cask apparatus according to exemplary claim 33 further comprising: the plurality of shield rings comprising a lowermost shielding ring, an uppermost shielding ring, and a plurality of middle shielding rings; and each of the middle shielding rings comprising a plurality of axially extending neutron poison passageways; and neutron absorbing components disposed in at least some of the axially-extending neutron poison passageway.

Exemplary claim 35. The radiation shielding cask apparatus according to exemplary claim 34 wherein each of the middle shielding rings comprises a top surface, a bottom surface, and a circumferential channel formed the top surface that is in spatial communication with each of axially-extending neutron poison passageways.

Exemplary claim 36. The radiation shielding cask apparatus according to exemplary claim 35 wherein, for each of the middle shielding rings, the circumferential channel is also in spatial communication with each of the axially-extending neutron poison passageways of an adjacent one of the middle shielding rings in the stacked assembly that is above the middle shielding ring.

Exemplary claim 37. The radiation shielding cask apparatus according to any one of exemplary claims 34 to 36 wherein the uppermost shielding ring comprises one or more pressure relief valves that are in spatial communication with the axially-extending neutron poison passageways of the middle shielding rings to allow off-gasses from the neutron absorbing components to escape upon a predetermine pressure being reached.

Exemplary claim 38. The radiation shielding cask apparatus according to exemplary claim 37 wherein the one or more pressure relief valves are operatively coupled to the channel of a top one of the middle shielding rings.

Exemplary claim 39. The radiation shielding cask apparatus according to any one of exemplary claims 34 to 38 wherein each of the neutron absorbing components nest entirely within a singular one of the middle shielding rings.

Exemplary claim 40. The radiation shielding cask apparatus according to any one of exemplary claims 34 to 39 wherein each of the axially-extending neutron poison passageways has circular transverse cross-sectional profile.

Exemplary claim 41. The radiation shielding cask apparatus according to any one of exemplary claims 34 to 40 wherein, for each of the middle shielding rings, the axially-extending neutron poison passageways are arranged so that a radial line extending from a central axis of the cavity to an outer surface of the middle shielding ring without passing through one of the axially-extending neutron poison passageways does not exist.

Exemplary claim 42. The radiation shielding cask apparatus according to exemplary claim 41 wherein, for each of the middle shielding rings, the axially-extending neutron poison passageways comprises: a first set of axially-extending neutron poison passageways arranged in a spaced-apart manner about a first circumference of the middle shielding ring that is located a first radial distance from a central axis of the cavity; and a second set of axially-extending neutron poison passageways arranged in a spaced-apart manner about a second circumference of the middle shielding ring that is located a second radial distance from the central axis of the cavity, the second distance being less than the first distance.

Exemplary claim 43. The radiation shielding cask apparatus according to exemplary claim 42 wherein the first set of axially-extending neutron poison passageways are angularly offset from the second set of axially-extending neutron poison passageways.

Exemplary claim 44. The radiation shielding cask apparatus according to any one of exemplary claims 41 to 42 wherein the axially-extending neutron poison passageways of the first set are equi-spaced from one another and the axially-extending neutron poison passageways of the second set are equi-spaced from one another.

Exemplary claim 45. The radiation shielding cask apparatus according to any one of exemplary claims 41 to 24 wherein the axially-extending neutron poison passageways of the first set have a first transverse cross-sectional diameter and the axially-extending neutron poison passageways of the second set have a second transverse cross-sectional diameter, the second transverse cross-sectional diameter being smaller than the first transverse cross-sectional diameter.

Exemplary claim 46. The radiation shielding cask apparatus according to any one of exemplary claims 18 to 24 wherein, for each of the middle shielding rings, the axially-extending neutron poison passageway are located in an outer peripheral region of the middle shielding ring Exemplary claim 47. The radiation shielding cask apparatus according to any one of exemplary claims 34 to 46 further comprising: each of the middle shielding rings comprising a plurality of axially-extending gamma blocker passageways; and gamma absorbing components disposed in at least some of the axially-extending gamma poison passageways.

Exemplary claim 48. The radiation shielding cask apparatus according to exemplary claim 47 wherein each of the gamma blocking components nest entirely within a singular one of the middle shielding rings.

Exemplary claim 49. The radiation shielding cask apparatus according to any one of exemplary claims 32 to 49 further comprising a plurality of canister support elements coupled to a bottom portion of the cask body and alterable between: (1) a canister support state in which the canister support elements protrude into the cavity and prohibit the canister from being removed from the cavity via the bottom end of the cavity when the bottom lid is in the open state; and (2) a canister unloading state in which the canister support elements are retracted and allow the canister to be removed from the cavity via the bottom end of the cavity when the bottom lid is in the open state.

Exemplary claim 50. A radiation shielding cask apparatus comprising: a cask body defining a cavity configured to receive a canister containing spent nuclear fuel, the cask body comprising a plurality of axially-extending neutron poison passageways, each of the axially-extending neutron poison passageways having a circular transverse cross-sectional profile, the axially-extending neutron poison passageways arranged so that a radial line extending from a central axis of the cavity to an outer surface of the cask body without passing through one of the axially-extending neutron poison passageways does not exist at an axial height of the spent nuclear fuel in the cavity; neutron absorbing material disposed in the axially-extending neutron poison passageways; and a bottom lid detachably coupled to the cask body to enclose a bottom end of the cavity.

Exemplary claim 51. The radiation shielding cask apparatus according to exemplary claim 50 wherein the axially-extending neutron poison passageways comprises: a first set of axially-extending neutron poison passageways arranged in a spaced-apart manner about a first circumference of the cask body that is located a first radial distance from a central axis of the cavity; and a second set of axially-extending neutron poison passageways arranged in a spaced-apart manner about a second circumference of the cask body that is located a second radial distance from the central axis of the cavity, the second distance being less than the first distance.

Exemplary claim 52. The radiation shielding cask apparatus according to exemplary claim 51 wherein the axially-extending neutron poison passageways comprises: a first set of axially-extending neutron poison passageways arranged in a spaced-apart manner about a first circumference of the cask body that is located a first radial distance from a central axis of the cavity; and a second set of axially-extending neutron poison passageways arranged in a spaced-apart manner about a second circumference of the cask body that is located a second radial distance from the central axis of the cavity, the second distance being less than the first distance.

Exemplary claim 53. The radiation shielding cask apparatus according to exemplary claim 52 wherein the first set of axially-extending neutron poison passageways are angularly offset from the second set of axially-extending neutron poison passageways.

Exemplary claim 54. The radiation shielding cask apparatus according to any one of exemplary claims 52 to 53 wherein the axially-extending neutron poison passageways of the first set are equi-spaced from one another and the axially-extending neutron poison passageways of the second set are equi-spaced from one another.

Exemplary claim 55. The radiation shielding cask apparatus according to any one of exemplary claims 52 to 54 wherein the axially-extending neutron poison passageways of the first set have a first transverse cross-sectional diameter and the axially-extending neutron poison passageways of the second set have a second transverse cross-sectional diameter, the second transverse cross-sectional diameter being smaller than the first transverse cross-sectional diameter.

Exemplary claim 56. The radiation shielding cask apparatus according to any one of exemplary claims 50 to 55 wherein the axially-extending neutron poison passageway are located in an outer peripheral region of the cask body.

Exemplary claim 57. The radiation shielding cask apparatus according to any one of exemplary claims 50 to 56 wherein the axially-extending neutron poison passageways extend a majority of the axial length of the cask body.

Exemplary claim 58. The radiation shielding cask apparatus according to any one of exemplary claims 50 to 58 further comprising: the cask body comprising a plurality of axially-extending gamma blocker passageways; and a gamma absorbing material disposed in at least some of the axially-extending gamma blocker passageways.

Exemplary claim 59. A radiation shielding cask apparatus comprising: a cask body comprising: a cavity configured to receive a canister containing spent nuclear fuel and extending along a central axis; a plurality of axially-extending neutron poison passageways in an outer peripheral region of the cask body; a plurality of axially-extending gamma blocker passageways in an inner peripheral region of the cask body; neutron absorbing components disposed in at least some of the axially-extending neutron poison passageways; gamma absorbing components disposed in at least some of the axially-extending gamma blocker passageways; and a bottom lid detachably coupled to the cask body to enclose a bottom end of the cavity.

Exemplary claim 60. A system for transferring high level radioactive waste comprising: the radiation shielding cask apparatus according to any one of exemplary claims 1 to 59; and the canister loaded with high level radioactive waste positioned within the cavity of the radiation shielding cask apparatus.

Exemplary claim 61. A method of transferring a canister containing high level radioactive waste from a radiation shielding cask apparatus to a secondary containment structure, the method comprising: a) positioning the radiation shielding cask apparatus above the secondary containment structure, the radiation shielding cask apparatus comprising a cask body defining a cavity and a bottom lid coupled to the cask body to enclose a bottom end of the cavity, the canister located within the cavity and resting atop and supported by a plurality of canister support elements coupled to the cask body; b) removing the bottom lid of the radiation shielding cask apparatus from the cask body to open the bottom end of the cavity; c) retracting the canister support elements to a position in which the canister support elements no longer obstruct the bottom end of the cavity; and d) lowering the canister from the cavity of the radiation shielding cask apparatus into a receiving cavity of the secondary containment structure.

Exemplary claim 62. The method according to exemplary claim 61 wherein step c) further comprises: lifting the canister to remove the canister's weight from the canister support elements; and retracting the canister support elements while the canister's weight is removed from the canister support elements.

Exemplary claim 63. The method according to any one of exemplary claims 61 to 62 wherein step b) further comprises: removing the bottom lid of the radiation shielding cask apparatus from the cask body to open the bottom end of the cavity; and lowering the radiation shielding cask apparatus while the canister remains supported by the canister support elements until the radiation shielding cask apparatus contacts and is positioned atop the secondary containment structure in a stacked arrangement where the cavity and receiving cavity are axially aligned with one another.

Exemplary claim 64. The method according to any one of exemplary claims 61 to 63 wherein step c) further comprises: withdrawing the canister support elements radially outward until the canister support elements no longer obstruct the bottom end of the cavity to allow the canister to pass therethrough.

Exemplary claim 65. The method according to any one of exemplary claims 61 to 64 wherein the cask body comprises a plurality of passageways extending from an outer surface of the cask body to an inner surface of the cask body, each of the canister support elements mounted within one of the passageways; and wherein step c) further comprises retracting each of the canister support elements from a position in which a distal portion of the canister support element protrudes from the inner surface of the cask body and into the cavity to the position in which the canister support element no longer obstructs the bottom end of the cavity.

Exemplary claim 66. The method according to exemplary claim 65 wherein, for each of the canister support elements, the distal portion comprises a flat upper surface upon which the canister is supported in step b).

Exemplary claim 67. The method according to exemplary claim 66 wherein each of the canister support elements comprises a spindle slidably mounted within one of the passageways.

Exemplary claim 68. The method according to any one of exemplary claims 61 to 65 wherein during step a) the canister is positioned within the cavity of the radiation shielding cask apparatus so that an annular gap exists between an outer surface of the canister and the inner surface of the cask body, and the canister support elements support the canister above a top surface of the bottom lid so that a gap exists the top surface of the bottom lid and the bottom surface of the canister.

Exemplary claim 69. The method according to any one of exemplary claims 61 to 68 wherein during step a), the canister support elements are locked in place supporting the canister.

Exemplary claim 70. The method according to exemplary claim 69 wherein step c) further comprises: unlocking the canister support elements; and retracting the canister support elements to the position in which the canister support elements no longer obstruct the bottom end of the cavity.

Exemplary claim 71. The method according to exemplary claim 69 wherein the unlocking step comprises removing locking elements from the cask body that prevent the canister support elements from moving.

Exemplary claim 72. The method according to any one of exemplary claims 61 to 71 wherein during step a), the bottom end of the cavity is hermetically sealed and the canister is hermetically sealed.

Exemplary claim 73. The method according to any one of exemplary claims 61 to 72 further comprising, prior to step a): positioning the canister in the cavity of the radiation shielding cask apparatus, a top end of a canister cavity of the canister being open and a top end of the cavity being open, an annular seal positioned between the canister and the cask body to hermetically seal a top end of an annular gap located between the canister and the cask body to the ingress of water, and the bottom end of the cavity being hermetically sealed to the ingress of water; submerging the radiation shielding cask apparatus and the canister in a pool of water; loading the canister with spent nuclear fuel rods; enclosing the top end of the canister cavity with a canister lid; and removing the radiation shielding cask apparatus and the canister from the pool of water.

Exemplary claim 74. The method according to any one of exemplary claims 61 to 74 wherein the secondary containment structure is selected from a group consisting of a storage cask, a transfer cask, and a ventilated storage unit.

Exemplary claim 75. A method of manufacturing a radiation shielding cask apparatus comprising: a) forming a plurality of middle shielding rings, each of the middle shielding rings comprising a ring cavity, a central ring axis, and a plurality of axially-extending neutron poison passageways; b) inserting neutron absorbing components into the axially-extending neutron poison passageways of each of the middle rings; and c) stacking the middle shielding rings and welding the middle shielding rings together to form a cask body having a cavity collectively formed by the ring cavities.

Exemplary claim 76. The method according to exemplary claim 75 wherein step c) further comprises welding adjacent ones of the middle shield rings to each other along an inner circumference interface and an outer circumference interface.

Exemplary claim 77. The method according to any one of exemplary claims 75 to 76 wherein step a) further comprises forming the axially-extending neutron point passageways in each of the middle shielding rings in a pattern, the pattern configured so that a radial line extending from the ring central axis to an outer surface of the middle shielding ring without passing through one of the axially-extending neutron poison passageways does not exist.

Exemplary claim 78. The method according to any one of exemplary claims 75 to 77 further comprising: forming a bottom shielding ring; wherein step c) further comprises stacking the bottom and middle shielding rings and welding the bottom and middle shielding rings together to form the cask body.

Exemplary claim 79. The method according to exemplary claim 78 further comprising: drilling a plurality of radially-extending passageways in the bottom shielding ring that extend from an outer surface of the bottom shielding ring to the inner surface of the bottom shielding ring; and movably mounting canister support elements in the radial extending passageways so that the canister support elements can be altered between a canister support state and an unloading state.

Exemplary claim 80. The method according to exemplary claim 78 further comprising covering openings of the radially extending passageways to seal the radially extending passageways and lock the canister support elements in the canister support state.

Exemplary claim 81. The method according to any one of exemplary claims 75 to 80 further comprising: forming a top shielding ring and a bottom shielding ring; wherein step c) further comprises stacking the middle and top shielding rings and welding the middle and top shielding rings together to form the cask body.

Exemplary claim 82. The method according to any one of exemplary claims 75 to 81 wherein, for each of the middle shielding rings, step a) further comprises: forming a monolithic ring body; and drilling a plurality of axially-extending neutron poison passageways in the monolithic ring body.

Exemplary claim 83. The method according to exemplary claim 82 wherein, for each of the middle shielding rings, step a) further comprises forming a channel in at least one of a top or bottom surface of the shielding ring that is in spatial communication with all of the axially-extending neutron poison passageways.

Exemplary claim 84. The method according to any one of exemplary claims 75 to 83 further comprising: forming a top shielding ring; wherein step c) further comprises stacking the top shielding ring atop the middle shielding rings and welding the top shielding ring to the middle shielding rings to form the cask body.

Exemplary claim 85. The method according to exemplary claim 84 further comprising: forming pressure relief passageways in the top ring that are in spatial communication with the axially-extending neutron poison passageways; and operably coupling pressure relief valves to the pressure relief passageways.

Exemplary claim 86. The method according to any one of exemplary claims 75 to 85 wherein, for each of the middle shielding rings, the axially extending neutron passageway are located in an outer peripheral region of the middle shielding ring.

Exemplary claim 87. The method according to any one of exemplary claims 75 to 85 further comprising: for each of middle shielding rings, step a) further comprising forming the middle shielding ring with axially extending gamma blocker passageways in the middle shielding ring; and wherein step b) further comprises inserting gamma absorbing components into the axially-extending gamma blocking passageways of each of the middle shielding rings.

Exemplary claim 88. The method according to exemplary claim 87 wherein, for each of the middle shielding rings, the axially-extending gamma absorbing passageway are located in inner peripheral region of the middle shielding ring.

Exemplary claim 89. A method of manufacturing a radiation shielding cask apparatus comprising: a) forming a cask body having a central cavity configured to receive a canister containing high level radioactive waste, the cavity extending along a central axis; b) forming a plurality of radially-extending passageways in a bottom end of the cask body from an outer surface of the cask body to an inner surface of the cask body; and c) movably mounting canister support elements in the radial extending passageways so that the canister support elements can be altered between a canister support state and a canister unloading state.

Exemplary claim 90. The method according to exemplary claim 89 further comprising covering openings of the radially extending passageways to seal the radially extending passageways and lock the canister support elements in the canister support state.

Exemplary claim 91. The method according to any one of exemplary claims 89 to 90 wherein, in the canister support state, the canister support elements protrude into the cavity, support the canister, and prohibit the canister from being removed from the cavity via a bottom end of the cavity; and wherein, in the canister unloading state, the canister support elements are retracted and allow the canister to be removed from the cavity via the bottom end of the cavity when the bottom lid is removed from the cask body.

Exemplary claim 92. The method according to any one of exemplary claims 89 to 91 further comprising: detachably coupling a bottom lid a bottom end of the cask body to seal the bottom end of the cavity.

1.-92. (canceled)

93. A radiation shielding cask apparatus comprising:
a cask body defining a cavity configured to receive a canister containing spent nuclear fuel;
a bottom lid detachably coupled to the cask body to enclose a bottom end of the cavity; and
a plurality of canister support elements coupled to a bottom portion of the cask body and alterable between: (1) a canister support state in which the canister support elements protrude into the cavity, support the canister, and prohibit the canister from being removed from the cavity via the bottom end of the cavity; and (2) a canister unloading state in which the canister support elements are retracted and allow the canister to be removed from the cavity via the bottom end of the cavity when the bottom lid is removed from the cask body.

94. The radiation shielding cask apparatus according to claim 93 further comprising:
the cask body comprising a plurality of passageways extending from an outer surface of the cask body to an inner surface of the cask body; and
each of the canister support elements movably mounted within one of the passageways to be moved between the support state and the unloading state.

95. The radiation shielding cask apparatus according to claim 94 wherein, in the support state, a distal portion of each of the canister support elements protrude from the inner surface of the cask body and into the cavity; and wherein, in the unloading state, the distal portion of the canister support element is at least partially nested within the passageway.

96. The radiation shielding cask apparatus according to claim 95 wherein, for each of the canister support elements, the distal portion comprises a flat upper surface for contacting and supporting a bottom surface of the canister.

97. The radiation shielding cask apparatus according to claim 94 wherein each of the canister support elements is slidably mounted within the one of the passageways to be slidably translated between the support state and the unloading state.

98. The radiation shielding cask apparatus according to claim 94 wherein when the canister support elements are in the canister support state, the passageways are hermetically sealed to the external environment.

99. The radiation shielding cask apparatus according to claim 93 wherein, for each of the canister support elements, a tortuous interface exists between the canister support element and the cask body that prevents outward streaming of radiation from the canister to the external environment.

100. The radiation shielding cask apparatus according to claim 93 further comprising a plurality of locking elements associated with the canister support elements, each of the locking elements alterable between: (1) a first state in which an associated one of the cask support elements is locked in the canister support state; and (2) a second state in which the associated one of the cask support elements can be altered from the canister support state to the canister unloading state.

101. The radiation shielding cask apparatus according to claim 100 wherein each of the locking elements comprises a closure plate that is detachably coupled to an outer surface of the canister body and a seal located between the closure plate the outer surface of the cask body that is compressed in the first state.

102. The radiation shielding cask apparatus according to claim 93 further comprising:
the cask body comprising a plurality of axially-extending neutron poison passageways; a neutron absorbing material disposed in at least some of the axially-extending neutron poison passageways; and
wherein the axially-extending neutron poison passageways are arranged so that a radial line extending from a central axis of the cavity to an outer surface of the cask body without passing through one of the axially-extending neutron poison passageways does not exist.

103. The radiation shielding cask apparatus according to claim 102 wherein the axially-extending neutron poison passageways comprises:
a first set of axially-extending neutron poison passageways arranged in a spaced-apart manner about a first circumference of the cask body that is located a first radial distance from a central axis of the cavity; and
a second set of axially-extending neutron poison passageways arranged in a spaced-apart manner about a second circumference of the cask body that is located a second radial distance from the central axis of the cavity, the second distance being less than the first distance.

104. The radiation shielding cask apparatus according to claim 103 wherein the axially-extending neutron poison passageways of the first set have a first transverse cross-sectional diameter and the axially-extending neutron poison passageways of the second set have a second transverse cross-sectional diameter, the second transverse cross-sectional diameter being smaller than the first transverse cross-sectional diameter.

105. The radiation shielding cask apparatus according to claim 102 further comprising:
the cask body comprising a plurality of axially-extending gamma blocker passageways; and
a gamma absorbing material disposed in at least some of the axially-extending gamma blocker passageways.

106. The radiation shielding cask apparatus according to claim 93 further comprising:
the cask body comprising a plurality of shield rings arranged in a stacked assembly; and
wherein adjacent ones of the shield rings in the stacked assembly are coupled to each other.

107. A radiation shielding cask apparatus comprising:
a cask body defining a cavity configured to receive a canister containing spent nuclear fuel, the cask body comprising a plurality of shield rings arranged in a stacked assembly, wherein adjacent ones of the shield rings in the stacked assembly are coupled to each other; and
a bottom lid detachably coupled to the cask body to enclose a bottom end of the cavity.

108. The radiation shielding cask apparatus according to claim 107 further comprising:
the plurality of shield rings comprising a lowermost shielding ring, an uppermost shielding ring, and a plurality of middle shielding rings; and
each of the middle shielding rings comprising a plurality of axially extending neutron poison passageways; and
neutron absorbing components disposed in at least some of the axially-extending neutron poison passageway.

109. The radiation shielding cask apparatus according to claim 108 wherein each of the middle shielding rings comprises a top surface, a bottom surface, and a circumferential channel formed the top surface that is in spatial communication with each of axially-extending neutron poison passageways.

110. The radiation shielding cask apparatus according to claim 109 wherein, for each of the middle shielding rings, the circumferential channel is also in spatial communication with each of the axially-extending neutron poison passageways of an adjacent one of the middle shielding rings in the stacked assembly that is above the middle shielding ring.

111. The radiation shielding cask apparatus according to claim 107 wherein the uppermost shielding ring comprises one or more pressure relief valves that are in spatial communication with the axially-extending neutron poison passageways of the middle shielding rings to allow off-gasses from the neutron absorbing components to escape upon a predetermine pressure being reached.

112. A method of transferring a canister containing high level radioactive waste from a radiation shielding cask apparatus to a secondary containment structure, the method comprising:
a) positioning the radiation shielding cask apparatus above the secondary containment structure, the radiation shielding cask apparatus comprising a cask body defining a cavity and a bottom lid coupled to the cask body to enclose a bottom end of the cavity, the canister located within the cavity and resting atop and supported by a plurality of canister support elements coupled to the cask body;
b) removing the bottom lid of the radiation shielding cask apparatus from the cask body to open the bottom end of the cavity;
c) retracting the canister support elements to a position in which the canister support elements no longer obstruct the bottom end of the cavity; and
d) lowering the canister from the cavity of the radiation shielding cask apparatus into a receiving cavity of the secondary containment structure.
